(19) United States
(12) Patent Application Publication
(10) Pub. No.: US 2009/0115915 A1
(43) Pub. Date: May 7, 2009

(54) Camera Based Feedback Loop Calibration of a Projection Device

(75) Inventors: Eran Steinberg, San Francisco, CA (US); Alexandru Drimbarean, Galway (IE)

Correspondence Address: Tessera/FotoNation;Patent Legal Dept., 3025 Orchard Parkway, San Jose, CA, 95134, US

(73) Assignee: FOTONATION VISION LIMITED, Galway City (IE)

(21) Appl. No.: 11/835,790

(22) Filed: Aug. 8, 2007

Related U.S. Application Data
(60) Provisional application No. 60/821,954, filed on Aug. 9, 2006.

(51) Int. Cl. H04N 3/22; G03B 21/14; H04N 9/31

(52) U.S. Cl. 348/745; 353/122; 353/69; 353/121; 348/E09.025

(57) ABSTRACT

A system is provided for projecting a calibrated image. The system includes a projector to project an uncalibrated image. A processor-based digital image acquisition device is in communication with the projector and is disposed to acquire the projected, uncalibrated image. The device is also programmed to compensate for one or more parameters of viewing quality, and to communicate calibration information to the projector to project a first calibrated image.

### PRIORITY

This application claims the benefit of priority to U.S. provisional patent application No. 60/821,954, filed Aug. 9, 2006, which is incorporated by reference.

### BACKGROUND

1. Field of Invention

The invention relates to digital projection systems and in particular to methods of calibrating the projected image using an acquisition device.

2. Description of the Related Art

Projectors are used to display images on a wall or enlarged screen surface when the images are to be viewed by a large group or audience. The images are generally enlarged compared with their original film or digitized format size, e.g., for viewing on a computer screen or a print out. Projected images are often changed in ways that may or may not be specifically predictable. For example, the wall surface or screen upon which the images are projected will vary, for example, in contour or color. Also, the aspect ratio and overall size of the images will vary depending on the relationship between the location of the projector and the location on the wall or screen to which the images are projected, including the angle of projection relative to a normal to the wall or screen surface.

Typical use of image projection, e.g., in conference rooms, puts restraints on both projector location and on the location on a white or other colored wall as a projection surface. The projection image will generally have to be relatively centered if everyone in the group gathered in the conference room will be able to view the images without straining. It is desired to be able to accommodate and adjust for these and/or other kinds imperfections of the wall or screen projection surface and/or relative location to enhance a viewing experience.

Some projectors today have PC (Perspective Correction) lenses. Besides being more expensive and requiring mechanical movement, projectors with PC lenses are generally not capable of sufficient replication of pictures or other images being projected, particularly in settings with unpredictable variability. The Canon-LV-7255 has a special mode to account for different surfaces. The Canon LV-7255 also includes components for changing the color of a projected image, but it is limited to a small subset of options involving customer knowledge.

### Tiny Projector Embeds in Mobile Devices

There exists a relatively recently introduced tiny device that can project a color image from a mobile hardware device (see, e.g., U.S. Pat. No. 7,128,420 and US published applications 2007/0047043, 2006/0279662 and 2006.0018025, and http://www.explay.co.il, which are all hereby incorporated by reference). Israel-based Explay™ says its “nano-projector engine” produces eye-safe, always-focused images from mobile devices such as phones, portable media players, and camcorders, and yields an image that is 7 to 35 inches diagonal, which is large enough for sharing in small groups.

Explay™ says that its laser-based diffractive optical technology is a proprietary method for enhancing micro-display efficiency. Designed to work with or be embedded in a camera-phone or other device, the match-box sized hardware is described as being “100 times” better than previously or other currently available projectors in terms of combined size and efficiency. An even smaller version of the nano-projector engine is scheduled for introduction in the beginning of 2007. Explay™ has cited forecasts that more than 60 million portable devices with projector capabilities will be sold by the year 2010.

### SUMMARY OF THE INVENTION

A system is provided for projecting a calibrated image. The system includes a projector to project an uncalibrated image. A processor-based digital image acquisition device is in communication with the projector and is disposed to acquire the projected, uncalibrated image. The device is also programmed to compensate for one or more parameters of viewing quality, and to communicate calibration information to the projector to project a first calibrated image.

A further system is provided to project a calibrated image. The system includes a projector to project an uncalibrated image. A processor-based digital image acquisition device is in communication with the projector and disposed to acquire a series of projected, uncalibrated images. The device is also programmed to iteratively compensate for one or more parameters of viewing quality, and to communicate calibration information to the projector to project a first calibrated image. The iterative compensation may be based on projection of consecutive uncalibrated images to determine an appropriate correction.

A further system for projecting a calibrated image is provided. The system includes a projector for projecting a first image. A processor-based device is in communication with the projector. A camera acquires a projected first image and communicating first image data to processor-based device, which is programmed to analyze the first image data and to compensate for one or more parameters of viewing quality, and to communicate calibration information to the projector for projecting a calibrated second image.

A further system for projecting a calibrated image is provided. A processor-based projector is for projecting an uncalibrated image. A digital image acquisition device is in communication with the projector and is disposed to acquire the projected, uncalibrated image. The processor-based projector is programmed to compensate for one or more parameters of viewing quality, and to project a first calibrated image.

A device is also provided to project a calibrated image. A housing includes one or more accessible user interface switches and one or more optical windows defined therein. A projector component is within the housing for projecting an uncalibrated image. A processor is disposed within the housing. A digital image acquisition component within the housing is disposed to acquire the projected, uncalibrated image. A memory has program code embedded therein for programming the processor to compensate for one or more parameters of viewing quality in the uncalibrated image, and to generate a first calibrated image for projection by the projector component.

The one or more viewing quality parameters may include local or global color, saturation, relative exposure, geometrical distortions or perspective, or combinations thereof.

The digital image acquisition device may be further programmed to acquire the projected first calibrated image, compensate for one or more same or different viewing quality parameters, and communicate further calibration information to the projector for projecting a second calibrated image. The device may be further programmed to acquire the projected first calibrated image when a sensor detects that the projector has been moved.

The digital image acquisition device may be programmed to acquire the projected uncalibrated image when the projector is set.

The calibration information may include focus and/or color adjustment based on a detected local or global color or colors or texture or combinations thereof of a background upon which the uncalibrated image is projected. The calibration information may include geometrical perspective adjustment including changing a length of at least one side of a projected polygon and/or individually changing lengths of any of four sides of a projected polygon.

The processor-based digital image acquisition device may be enclosed in a projector encasement or may be external to the projector such as on a personal computer.

A method of projecting a calibrated image is provided. The method includes projecting an uncalibrated image; acquiring the projected, uncalibrated image; compensating for one or more parameters of viewing quality; and projecting a first calibrated image.

The method may further include acquiring the projected first calibrated image; compensating for one or more same or different viewing quality parameters; and projecting a second calibrated image and/or communicating calibration information for the projecting of the first or second calibrated images, or both.

The acquiring of the first calibrated image may include sensing that the projector has been moved and/or determining an occurrence of projecting.

The calibration information may include color adjustment based on a detected color of a background upon which the uncalibrated image is projected, perspective adjustment including changing a length of a side of a projection polygon, focus, and/or geometrical perspective adjustment including individually changing lengths of any of four sides of a projected polygon.

A further method of projecting a calibrated image is provided. The method includes projecting an uncalibrated image; acquiring a series of projected, uncalibrated images; iteratively compensating for one or more parameters of viewing quality; and communicating calibration information for projecting a first calibrated image. The iterative compensating may be based on projection of consecutive uncalibrated images to determine an appropriate correction.

One or more computer readable media having encoded therein computer readable code for programming a processor to control any of the methods of projecting a calibrated image as described herein.

### BRIEF DESCRIPTION OF THE DRAWINGS

FIG. 1 illustrates a flow process of actions performed by a system including a computer, projector and camera in accordance with an embodiment.

FIGS. 2A-2B schematically illustrate systems according to embodiments each including a projector and a camera.

FIG. 3A-3D schematically illustrate further systems according to embodiments each including a projector and a camera.

FIG. 4 illustrates a flow process of actions performed by a system including a computer, projector and camera in accordance with a further embodiment.

### DETAILED DESCRIPTION OF THE EMBODIMENTS

Embodiments are provided for combining a projector and an image acquisition device such as a camera or a camera-equipped mobile device such as a phone, internet device and/or music player, or portable, hand-held or desktop computer, set-top box, video game console or other equipment capable of acquiring analog or digital images (hereinafter “camera”). In general, images are projected and controlled using a closed loop calibration between the projector and the camera. A projector may have a small camera built-in or a camera or phone or other device may have a projector built-in or the camera and projector may be separate or connectable components. In this case, adjustments can happen instantaneously or at least highly efficiently and very effectively.

In the closed loop system that is provided herein between the projector and the camera, a test image may be projected on a wall. The camera records the projected image. Color and/or perspective distortions are compensated, e.g., using digital processing code stored on the camera, projector or a third device such as a computer. If the new image is processed on the projector, then it may be projected immediately by the projector. If the new image is processed on the camera or other device, then the new image may be transmitted to the projector first. When the new image is projected, the camera may acquire the new image and calculate the difference between the new image and the original image. The process may be iterative until it is determined that an ideal image is projected.

Advantageously, this process obviates conventional acts of manually shifting a projector until an image appears straight. Moreover, the adjusting of color, e.g., based on the color of the wall, enhances the projected image. Additional advantage will become clear in the case where acquisition devices will be equipped with projection display capabilities.

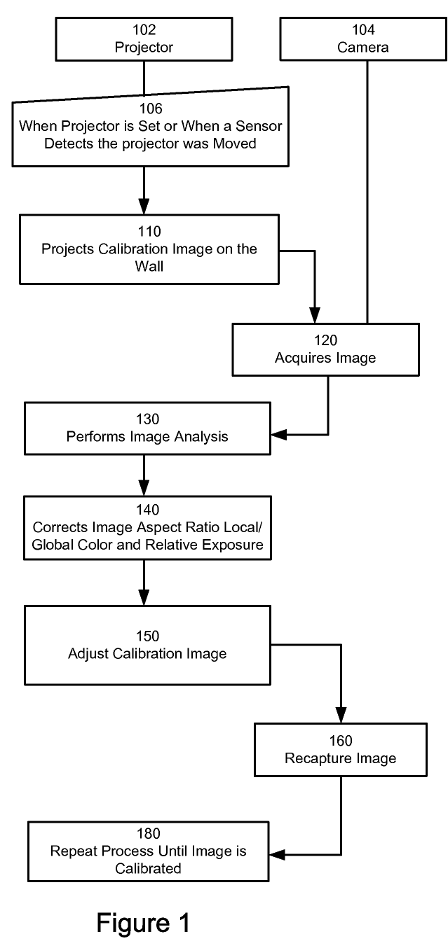

FIG. 1 illustrates a flow process of actions performed by a system including a projector 102 and camera 104 in accordance with an embodiment. The actions performed by the projector 102 are shown below the projector block 102 and those performed by the camera are shown below the camera block 104. Again, the distinction may be academic if an integrated camera-projector device is used. The projector 102 and camera 104 are coupled together so that the camera can transmit images to the projector to be projected, or to be processed so that a new image can be projected based on the transmitted image. Original images may be loaded on the camera 104 or directly on the projector 102, but in either of these embodiments, the camera acquires an image at 120 and a modified image is generated, e.g., on the camera, projector or other device, based on the acquired image for projection by the projector 102.

At 106, the projector 102 is set, e.g., in a position wherein it can project an image onto a wall or screen surface. The projector 106 projects a calibration image onto the wall at 110 in response. The calibration image may be a special calibration image stored in the projector or camera or connected computer, or it may be a first image of a series of images desired to be displayed for viewing by a gathered group or individual.

The projector 102 may have a button that a user can press indicating a desire to project an image at 106. A sensor may detect that the projector has been moved at 106 which may be used to trigger projection of the calibration image on the wall at 110. Such sensor may be located on the projector or a device connected to the projector such as the camera 104 or a special wall or screen surface sensor. There may be a special button that a user can press at 106 indicating to the projector 102 that it is time to project a calibration image at 110. Many other implementations are possible, such as a light sensor on the projector 102 or camera 104 indicating that someone has entered a conference room which may trigger at 106 projection of the calibration image at 110. A conference will which use image projection may be scheduled at a particular time, and the projector 102 may project the calibration image a few minutes before that time. The projector 102 and camera 104 may be synchronized such that their being connected together may trigger at 106 the projection of the calibration image at 110.

When the calibration image is projected at 110, the camera 104 acquires the image at 120. The actions 130, 140 and 150 are shown in FIG. 1 as being performed on the projector 102, but any or all of these may be performed on the camera 104 or another device coupled with the camera 104 and/or projector 102. An analysis is performed at 130 on the image acquired at 120. Based on the analysis at 130, one or more of an aspect ratio, local and/or global color and/or relative exposure are corrected at 140, unless the analysis determines that the acquired image 120 already matches ideal parameter conditions. Other parameters may be analyzed and corrected as understood by those skilled in the art (see, e.g., US published applications nos. 2005/0041121, 2005/0140801, 2006/0204055, 2006/0204110, 2005/0068452, 2006/0098890, 2006/0120599, 2006/0140455, 2006/0288071, 2006/0282572, 2006/0285754, 2007/0110305 and U.S. application Ser. No. 10/763,801, Ser. No. 11/462,035, Ser. No. 11/282,955, Ser. No. 11/319,766, Ser. No. 11/673,560, Ser. No. 11/464,083, Ser. No. 11/744,020, Ser. No. 11/460,225, Ser. No. 11/753,098, Ser. No. 11/752,925, Ser. No. 11/690,834, Ser. No. 11/765,899, which are assigned to the same assignee as the present application and are hereby incorporated by reference).

The calibration image is adjusted at 150 based on the analysis and correcting at 130 and 140. Other images are preferably adjusted based on the analysis and correcting at 130 and 140 either at 150, or after one or more further iterations of 110, 120, 130 and 140. That is, after 150, the process may return to 110 and repeat until it is determined that the current correct image being projected is ideal. This is indicated at blocks 160 and 180 in FIG. 1.

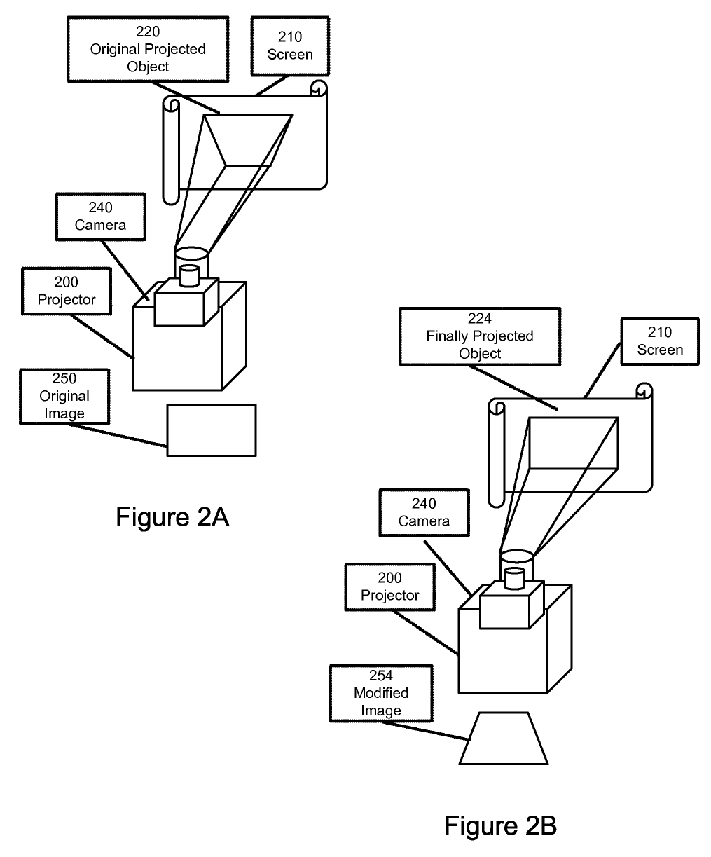

FIGS. 2A-2B schematically illustrate systems according to embodiments each including a projector 200 and a camera 240. The system of FIG. 2A illustrates an original image that is stored somewhere on the system or on an external device coupled to the system or a component of the system. The original image 250 is projected onto screen 210 or a wall or other surface. The original projected object 220 is shown in FIG. 2A skewed compared with the original image 250. In the example of FIG. 2A, the projector 200 is below the screen 210 causing the rectangular original image 250 is display on the screen 210 as an upside-down trapezoid, i.e., the top side of the original rectangular image is now projected onto the screen 210 longer than the bottom side. In general, all of the objects of various shapes will be distorted proportionately until the projection artifact is corrected by a process in accordance with an embodiment.

FIG. 2B illustrates at block 254 a modified image shown as a rightside-up trapezoid. By modifying the original image in accordance with the proportion discovered by acquiring the original projected image 220 at block 120 of FIG. 1 followed by performing blocks 130, 140 and 150, and optionally 160 and/or 180, the finally projected image 224 appears rectangular, as desired in accordance with the original image 250.

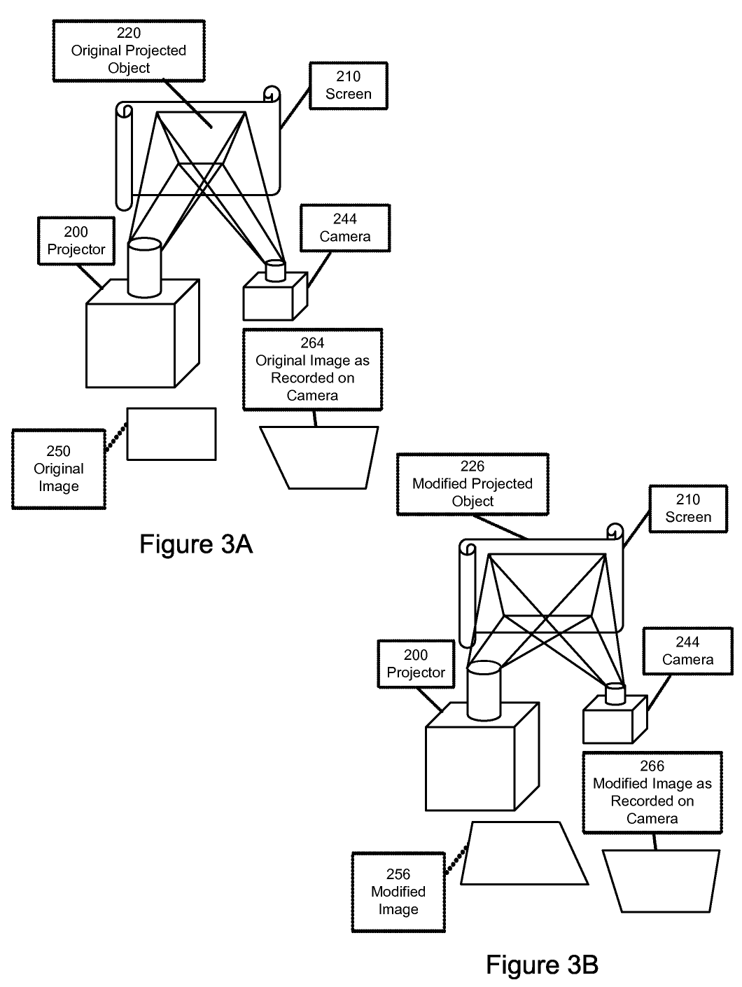

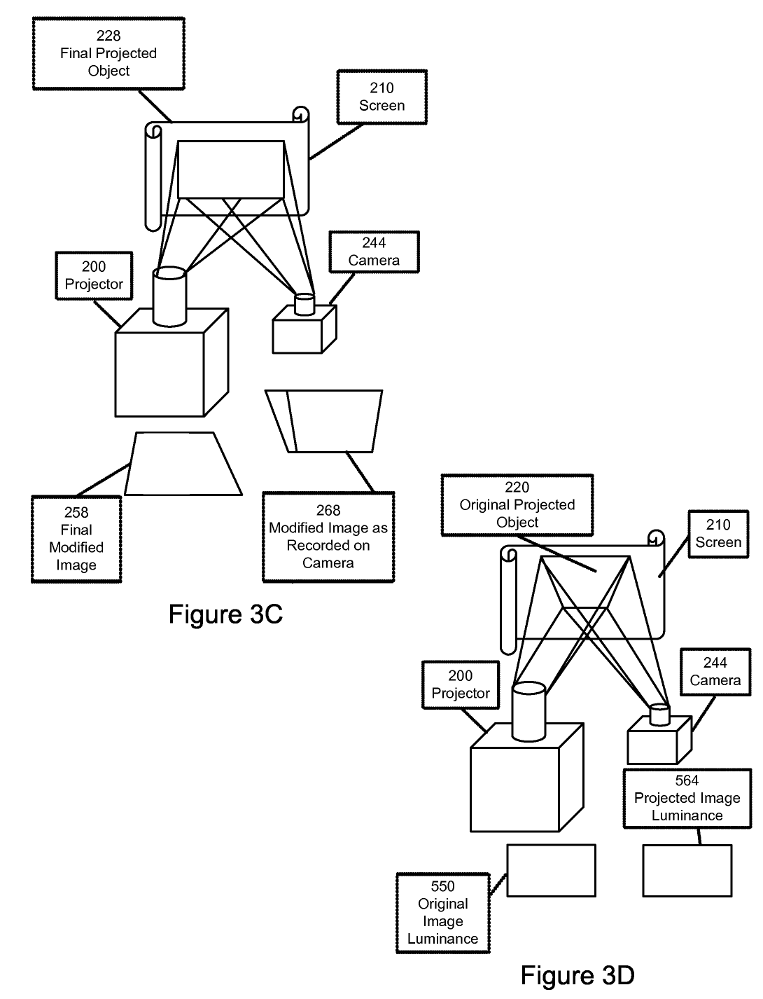

FIG. 3A-3D schematically illustrate further systems according to embodiments each including a projector 200 and a camera 244. The embodiments of FIGS. 3A-3D differ from those of FIGS. 2A-2B in that the projector 200 and camera 244 are physically separated components. The camera 244 may be, but does not need to be, right next to the projector 200 or built-in to a device including projector 200 such as camera 240 of FIGS. 2A-2B. For example, a web camera or web cam on a PC may be used which may be disposed several feet from a projector 200.

In these embodiments, it may not known or at least predictable in advance how the camera 244 will be disposed relative to the projector 200. Thus, the process may include initially adjusting the image 264 original recorded on the camera 264 upon projection of an original image 250 by projector 200. As shown in FIG. 3A, the original projected object was supposed to be a rectangular image 250, but is projected as an upside-down trapezoid, probably because the screen 210 is higher than the projector 200.

Referring now to FIG. 3B, when the modified image 256 is projected by projector 200 onto screen 210, a modified projected object 226 is acquired by camera 244. The modified image 266 recorded on the camera 244 still appears skewed due to the camera 244 not taking into account its relative position to the projector 200.

Referring now to FIG. 3C, further adjustments are performed and a final modified image 258 is provided for projection by projector 200. The Final projected object 228 now appears on the screen 210 as a rectangle, just as the original image 250 appeared in FIG. 3A. Interestingly, the modified image as recorded on the camera 268 does not appear as a rectangle to the camera 268, because in this case a properly corrected image will not appear to the camera as the original image 250. The camera basically determines where it is located relative to the projector 200 based on what the modified image 266 of FIG. 3B looks like compared with the adjustments made. Math may be used such as is understood by those skilled in the art of Computational-Geometry.

The compensation can go beyond perspective correction. For example, in cases where the distance between the projector 200 and camera 244 is significant, the correction may also account for the overall brightness as illustrated at FIG. 3D. An original luminance image 550 is shown projected by projector 200 onto screen 210 as original projected object 220 which is acquired by the camera 244 as projected luminance image 564. In this case, the projector 200 is basically closer to the lower portion of the projected image 220 and thus the overall brightness is higher at the bottom or lower at the top than is desired, i.e., than according to the luminance distribution of the original image.

### Alternative Implementations

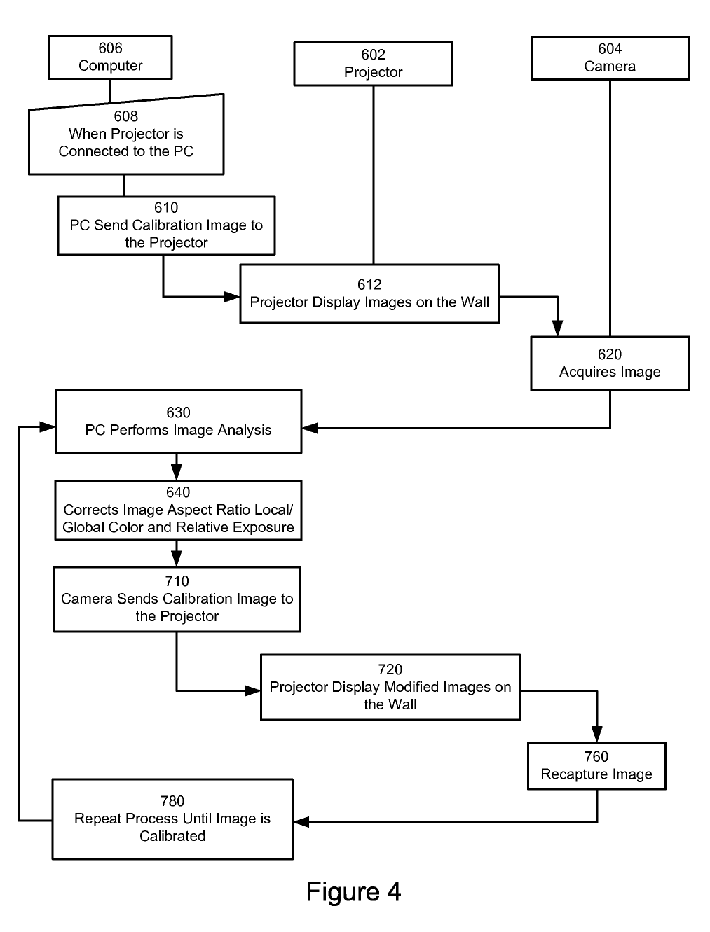

In accordance with a further embodiment, FIG. 4 illustrates a flow process of actions performed by a system including a projector 602, a camera 604 which could be any of various image acquisition devices or components, and a computer 606 which could be a PC or any of various processor-based devices or components including desktop, portable and handheld devices. The embodiment of FIG. 4 is one wherein the computer 606 is assumed to be connected to the projector 602. In this exemplary embodiment, calculations can be done on the computer 606 as part of a display driver. The camera 604 may be part of the projector 602 or may be an external component. Variations are possible including integrating the computer with the projector or the camera, and integrating all three components together in a single device. When the camera is separated from the projector by some distance and/or angle, then the additional calibration is performed similar to that described above with reference to FIGS. 3A-3D. Image correction is provided in this embodiment to the projector 602 as part of a modified image (e.g., with corrected perspective and distortion parameters) or may be calculated before being sent to the computer 606.

Referring now specifically to FIG. 4, the computer 606 sends a calibration image to the projector 602 at block 610. The projector 602 then displays the calibration image on the wall or other display screen or surface such as a ceiling, desk, floor, a person's hand, car seat, brief case, etc., at block 612. The camera 604 acquires an image of the projection on the wall or other surface at block 620. Image analysis is performed on the computer 606 at block 630, which means that the acquired image data is received at the computer 606 either directly from the camera 604, or through another device such as the projector 602 or a base station or local or wide area network or other peripheral device such as an access point, modem or router device. The computer 606 corrects image aspect ratio, local and/or global color and/or relative exposure and/or other image parameters (see references incorporated by reference above, for example).

The computer 606 then sends the calibration image to the projector 710 either directly or via the camera 604 or other device. The projector then displays at block 720 modified image on the wall or other display surface. The camera 604 recaptures the image at block 760, i.e., captures the modified image. If the modified image is analyzed by the computer 606 and determined to be ideal at a repeat of block 630, then the correction is stopped until another trigger event is detected, or if the modified image is still flawed, then the process is repeated as indicated at block 780 including actions 640, 710, 720, 760 and 630. Of course, an initial analysis of the original calibration image at 630 could reveal that no correction is needed, in which case blocks 640, 710, and 720 would be skipped.

The system may also be configured to analyze and correct for color. For example, if an original image is projected on a yellowish wall, the projected image may look more blue than desired. In this case, the system would correct the image accordingly by adding or subtracting appropriate RGB color components, which could be uniform for an uniformly yellow wall, or local for a wall of multiple colors. The system thus adapts to the surrounding color, and corrects projected images based on the appearance of the background.

The system may also be configured to correct for texture, contour and/or other shape imperfections on the wall (half white, half blue, e.g.) based on the knowledge of the image taken of the screen area. The over- or under-illumination or unbalanced illumination of the wall by artificial or natural light may also be compensated for. In general, the system is configured to modify parameters of an original image so that a projection of the modified image will appear to viewers like the original image.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents.

In addition, in methods that may be performed according to the claims below and/or preferred embodiments herein, the operations have been described in selected typographical sequences. However, the sequences have been selected and so ordered for typographical convenience and are not intended to imply any particular order for performing the operations, unless a particular ordering is expressly provided or understood by those skilled in the art as being necessary.

All references cited above, as well as that which is described as background, the invention summary, the abstract, the brief description of the drawings and the drawings, and US published application 2006/0284982, are hereby incorporated by reference into the detailed description of the preferred embodiments as disclosing alternative embodiments.

What is claimed is:

1. A system for projecting a calibrated image, comprising:
(a) a projector to project an uncalibrated image; and
(b) a processor-based digital image acquisition device in communication with the projector and disposed to acquire the projected, uncalibrated image, and programmed to compensate for one or more parameters of viewing quality, and to communicate calibration information to the projector to project a first calibrated image.

2. The system of claim 1, wherein the one or more viewing quality parameters include local or global color, saturation, relative exposure, geometrical distortions or perspective, or combinations thereof.

3. The system of claim 1, wherein the digital image acquisition device is further programmed to acquire the projected first calibrated image, compensate for one or more same or different viewing quality parameters, and communicate further calibration information to the projector for projecting a second calibrated image.

4. The system of claim 3, wherein the digital image acquisition device is programmed to acquire said projected first calibrated image when a sensor detects that the projector has been moved.

5. The system of claim 1, wherein the digital image acquisition device is programmed to acquire said projected uncalibrated image when the projector is set.

6. The system of claim 1, wherein said calibration information includes color adjustment based on a detected local or global color or colors or texture or combinations thereof of a background upon which the uncalibrated image is projected.

7. The system of claim 1, wherein said calibration information includes focus.

8. The system of claim 1, wherein the calibration information includes geometrical perspective adjustment including changing a length of at least one side of a projected polygon.

9. The system of claim 1, wherein the calibration information includes geometrical perspective adjustment including individually changing lengths of any of four sides of a projected polygon.

10. The system of claim 1 wherein said processor-based digital image acquisition device is enclosed in a projector encasement.

11. The system of claim 1 wherein said processor-based digital image acquisition device is external to said projector.

12. The system of claim 11, wherein said processor-based digital image acquisition device is located on a personal computer.

13. A system for projecting a calibrated image, comprising:
(a) a projector to project an uncalibrated image; and
(b) a processor-based digital image acquisition device in communication with the projector and disposed to acquire a series of projected, uncalibrated images, and programmed to iteratively compensate for one or more parameters of viewing quality, and to communicate calibration information to the projector to project a first calibrated image.

14. The system of claim 13, wherein the iterative compensation is based on projection of consecutive uncalibrated images to determine an appropriate correction.

15. A system for projecting a calibrated image, comprising:
(a) a projector to project a first image;
(b) a processor-based device in communication with the projector; and
(c) a camera to acquire the projected first image and to communicate first image data to processor-based device, which is programmed to analyze the first image data and to compensate for one or more parameters of viewing quality, and to communicate calibration information to the projector to project a calibrated second image.

16. The system of claim 15, wherein the one or more viewing quality parameters include local or global color, saturation, relative exposure, geometrical distortions or perspective, or combinations thereof.

17. The system of claim 16, wherein the processor-based device is further programmed to receive second image data from the camera upon further image acquisition by said camera, and to compensate for one or more same or different viewing quality parameters, and communicate further calibration information to the projector for projecting a further calibrated third image.

18. The system of claim 17, wherein the processor-based device is programmed to receive said second image data from said camera upon said further image acquisition by said camera when a sensor detects that the projector has been moved.

19. The system of claim 15, wherein the processor-based device is programmed to receive said first image data from said camera upon acquisition of said first image by said camera when the projector is set.

20. The system of claim 15, wherein said calibration information includes color adjustment based on a detected color of a background upon which the uncalibrated image is projected.

21. The system of claim 15, wherein the calibration information includes perspective adjustment including changing a length of a side of a projection polygon.

22. The system of claim 15, wherein said calibration information includes focus.

23. The system of claim 15, wherein the calibration information includes geometrical perspective adjustment including individually changing lengths of any of four sides of a projected polygon.

24. A system for projecting a calibrated image, comprising:
(a) a processor-based projector to project an uncalibrated image; and
(b) a digital image acquisition device in communication with the projector and disposed to acquire the projected, uncalibrated image, and
(c) wherein the processor-based projector is programmed to compensate for one or more parameters of viewing quality, and to project a first calibrated image.

25. The system of claim 24, wherein the one or more viewing quality parameters include local or global color, saturation, relative exposure, geometrical distortions or perspective, or combinations thereof.

26. The system of claim 24, wherein the processor-based projector is further programmed to receive image data of the projected first calibrated image from the digital image acquisition device, compensate for one or more same or different viewing quality parameters, and project a second calibrated image.

27. The system of claim 26, wherein the processor-based projector is programmed to receive image data of the projected first calibrated image from the digital image acquisition device when a sensor detects that the projector has been moved.

28. The system of claim 24, wherein the digital image acquisition device is programmed to acquire said projected uncalibrated image when the projector is set.

29. The system of claim 24, wherein said calibration information includes color adjustment based on a detected color of a background upon which the uncalibrated image is projected.

30. The system of claim 24, wherein the calibration information includes perspective adjustment including changing a length of a side of a projection polygon.

31. The system of claim 24, wherein said calibration information includes focus.

32. The system of claim 24, wherein the calibration information includes geometrical perspective adjustment including individually changing lengths of any of four sides of a projected polygon.

33. A device for projecting a calibrated image, comprising:
(a) a housing including one or more accessible user interface switches and one or more optical windows defined therein;
(b) a projector component within the housing to project an uncalibrated image;
(c) a processor within the housing; and
(d) a digital image acquisition component within the housing and disposed to acquire the projected, uncalibrated image, and
(e) a memory having program code embedded therein for programming the processor to compensate for one or more parameters of viewing quality in the uncalibrated image, and to generate a first calibrated image for projection by the projector component.

34. The device of claim 33, wherein the one or more viewing quality parameters include local or global color, saturation, relative exposure, geometrical distortions or perspective, or combinations thereof.

35. The device of claim 33, wherein the program code further includes programming for controlling acquisition of the projected first calibrated image by the digital image acquisition component, compensation for one or more same or different viewing quality parameters by the processor, and projection of a second calibrated image by the projector component.

36. The device of claim 35, wherein the program code further includes programming for controlling acquisition of said projected first calibrated image when a sensor detects that the projector has been moved.

37. The device of claim 33, wherein the program code further includes programming for controlling acquisition of said projected uncalibrated image when the projector is set.

38. The device of claim 33, wherein said calibration information includes color adjustment based on a detected color of a background upon which the uncalibrated image is projected.

39. The device of claim 33, wherein the calibration information includes perspective adjustment including changing a length of a side of a projection polygon.

40. The system of claim 33, wherein said calibration information includes focus.

41. The system of claim 33, wherein the calibration information includes geometrical perspective adjustment including individually changing lengths of any of four sides of a projected polygon.

42. A method of projecting a calibrated image, comprising:
(a) projecting an uncalibrated image;
(b) acquiring the projected, uncalibrated image;
(c) compensating for one or more parameters of viewing quality; and
(d) projecting a first calibrated image.

43. The method of claim 42, wherein the one or more viewing quality parameters include local or global color, saturation, relative exposure, geometrical distortions or perspective, or combinations thereof.

44. The method of claim 42, further comprising:
(i) acquiring the projected first calibrated image,
(ii) compensating for one or more same or different viewing quality parameters; and
(iii) projecting a second calibrated image.

45. The method of claim 44, further comprising communicating calibration information for the projecting of the first or second calibrated images, or both.

46. The method of claim 44, wherein the acquiring of the first calibrated image comprises sensing that the projector has been moved.

47. The method of claim 42, wherein the acquiring of the uncalibrated image comprises determining an occurrence of projecting.

48. The method of claim 42, wherein said calibration information includes color adjustment based on a detected color of a background upon which the uncalibrated image is projected.

49. The method of claim 42, wherein the calibration information includes perspective adjustment including changing a length of a side of a projection polygon.

50. The method of claim 42, further comprising communicating calibration information for the projecting of the first calibrated image.

51. The method of claim 50, wherein said calibration information includes focus.

52. The method of claim 50, wherein the calibration information includes geometrical perspective adjustment including individually changing lengths of any of four sides of a projected polygon.

53. A method of projecting a calibrated image, comprising:
(a) projecting an uncalibrated image;
(b) acquiring a series of projected, uncalibrated images;
(c) iteratively compensating for one or more parameters of viewing quality; and
(d) communicating calibration information for projecting a first calibrated image.

54. The method of claim 53, wherein said iteratively compensating is based on projection of consecutive uncalibrated images to determine an appropriate correction.

55. One or more computer readable media having encoded therein computer readable code for programming a processor to control a method of projecting a calibrated image, wherein the method comprises:
(a) projecting an uncalibrated image;
(b) acquiring the projected, uncalibrated image;
(c) compensating for one or more parameters of viewing quality; and
(d) projecting a first calibrated image.

56. The one or more media of claim 55, wherein the one or more viewing quality parameters include local or global color, saturation, relative exposure, geometrical distortions or perspective, or combinations thereof.

57. The one or more media of claim 55, wherein the method further comprises:
(i) acquiring the projected first calibrated image,
(ii) compensating for one or more same or different viewing quality parameters; and
(iii) projecting a second calibrated image.

58. The one or more media of claim 57, wherein the method further comprises communicating calibration information for the projecting of the first or second calibrated images, or both.

59. The one or more media of claim 57, wherein the acquiring of the first calibrated image comprises sensing that the projector has been moved.

60. The one or more media of claim 55, wherein the acquiring of the uncalibrated image comprises determining an occurrence of projecting.

61. The one or more media of claim 55, wherein said calibration information includes color adjustment based on a detected local or global color or colors or texture or combinations thereof of a background upon which the uncalibrated image is projected.

62. The one or more media of claim 55, wherein the calibration information includes perspective adjustment including changing a length of a side of a projection polygon.

63. The one or more media of claim 55, wherein the method further comprises communicating calibration information for the projecting of the first calibrated image.

64. The one or more media of claim 55, wherein said calibration information includes focus.

65. The one or more media of claim 55, wherein the calibration information includes geometrical perspective adjustment including individually changing lengths of any of four sides of a projected polygon.

66. One or more computer readable media having encoded therein computer readable code for programming a processor to control a method of projecting a calibrated image, wherein the method comprises:
(a) projecting an uncalibrated image;
(b) acquiring a series of projected, uncalibrated images;
(c) iteratively compensating for one or more parameters of viewing quality; and
(d) communicating calibration information for projecting a first calibrated image.

67. The one or more media of claim 66, wherein said iteratively compensating is based on projection of consecutive uncalibrated images to determine an appropriate correction.
